(19) United States
(12) Patent Application Publication
(10) Pub. No.: US 2011/0093190 A1
(43) Pub. Date: Apr. 21, 2011

(54) HEAD-UP DISPLAY NAVIGATION DEVICE, SYSTEM AND METHOD FOR IMPLEMENTING SERVICES

(76) Inventor: Woong-Cherl Yoon, Seoul (KR)

(21) Appl. No.: 12/936,888

(22) PCT Filed: Dec. 18, 2009
(86) PCT No.: PCT/KR09/07597

§ 371 Date: Jan. 3, 2011

(30) Foreign Application Priority Data
Dec. 18, 2008 (KR) 10-2008-0129421
Apr. 20, 2009 (KR) 10-2009-0034284

(51) Int. Cl. G01C 21/36

(52) U.S. Cl. 701/201; 701/213

(57) ABSTRACT

A Head-Up Display (HUD) navigation system, a head-up display navigation device, and a method for implementing an HUD service are provided. The HUD navigation system includes a server, a mobile terminal, and an HUD navigation device. The server generates GPS route data using departure point data, destination data, and previously stored road information data. The mobile terminal requests the server to generate GPS route data and provides GPS route data transmitted from the server. The HUD navigation device compares the GPS route data provided from the mobile terminal with current GPS position data to generate navigation data and projects at least one of a horizontally mirrored image, a horizontally mirrored character, or a horizontally mirrored numeric value corresponding to at least part of the navigation data onto a windshield.

### BACKGROUND

1. Field of the Invention

The present invention relates to a head-up display navigation device, a head-up display navigation system, and a method for implementing a head-up display navigation service, and more particularly to a head-up display navigation device, a head-up display navigation system, and a method for implementing a head-up display navigation service wherein the device or system provides navigation data in combination with a server which stores up-to-date road information.

2. Description of the Related Art

A head-up display projects an image onto a windshield which is a front screen of a car, an aircraft, or the like to form a virtual image on the windshield to allow the driver or pilot to check dashboard information or the like. Although the head-up display has thus far been primarily applied to military equipment such as fighter jets, implementation costs thereof have recently been reduced due to technological advances to the extent that the head-up display is now being applied to cars and some luxury cars are now available with head-up displays. Navigation systems are the most common function of head-up displays. A navigation system compares current GPS position data with map data and provides route guidance. Attempts have been made to use a head-up display to display navigation data to prevent accidents that may occur when the driver is viewing a display of the navigation system.

However, it is difficult to generate navigation data in real time based on up-to-date map data since the navigation data is generally based on map data that is previously stored in user equipment. Some navigation system uses a mobile phone to overcome this problem. However, since the user must purchase a navigation-enabled mobile phone including a GPS receiver, it is practically difficult to implement a head-up display navigation system based on up-to-date map data using a general mobile phone.

### SUMMARY

The present invention has been made in view of the above problems and it is an object of the present invention to provide a head-up display navigation device, a head-up display navigation system, and a method for implementing a head-up display navigation service, wherein it is possible to provide a head-up display navigation service based on up-to-date map data using a mobile terminal such as a mobile phone.

It is another object of the present invention to provide a head-up display navigation system that can receive and display not only navigation data but also preset information data from a server.

It is another object of the present invention to provide a head-up display navigation device which allows navigation data of a vehicle, in which the head-up display navigation device is installed, to be displayed to a driver outside the vehicle such as a driver of another vehicle at the rear side of the vehicle, thereby preventing accidents.

The above and other objects of the present invention will be described in or be apparent from the following description of the embodiments.

According to an aspect of the present invention, there is provided a head-up display navigation device including a data generating unit that compares current GPS position data with GPS route data provided from an external device and generates navigation data, and a light source unit that projects at least one of a horizontally mirrored image, a horizontally mirrored character, or a horizontally mirrored numeric value corresponding to at least part of the navigation data onto a windshield. The head-up display navigation device may further include an external display unit that displays at least one of an image, a character, and a numeric value corresponding to at least part of the navigation data.

According to another aspect of the present invention, there is provided a head-up display navigation system including a server that generates GPS route data using departure point data, destination data, and previously stored road information data, a mobile terminal that requests the server to generate GPS route data and provides GPS route data transmitted from the server to a head-up display navigation device, and the head-up display navigation device that compares the GPS route data provided from the mobile terminal with current GPS position data to generate navigation data and projects at least one of a horizontally mirrored image, a horizontally mirrored character, or a horizontally mirrored numeric value corresponding to at least part of the navigation data onto a windshield.

According to still another aspect of the present invention, there is provided a method for implementing a head-up display navigation service, the method including comparing current GPS position data with GPS route data provided from an external device to generate navigation data, and projecting at least one of a horizontally mirrored image, a horizontally mirrored character, or a horizontally mirrored numeric value corresponding to at least part of the navigation data onto a windshield.

The head-up display navigation device, the head-up display navigation system, and the method for implementing a head-up display navigation service according to the present invention have an advantage in that it is possible to provide a head-up display navigation service based on up-to-date map data stored in the server using, for example, a mobile phone. Thus, it is possible to reduce costs required to store map data in a user device and it is also possible to always provide a head-up display navigation service through up-to-date navigation data since the navigation data is generated by receiving, in real time, route data generated using up-to-date map data in the server.

In addition, it is possible to receive and present not only navigation data but also preset information data in real time from the server.

### BRIEF DESCRIPTION OF THE DRAWINGS

FIG. 1 is a block diagram of a head-up display navigation device according to an embodiment of the present invention.

FIG. 2 is a block diagram of a head-up display navigation system according to an embodiment of the present invention.

FIG. 3 is a flow chart of a method for implementing a head-up display navigation service according to an embodiment of the present invention.

FIG. 4 illustrates the front side of a head-up display navigation device according to an embodiment of the present invention.

FIG. 5 illustrates a head-up display screen according to an embodiment of the present invention.

FIG. 6 illustrates an example in which additional information is provided to a head-up display navigation device according to an embodiment of the present invention.

FIG. 7 is a block diagram illustrating how an ECU analysis signal is input to a head-up display device according to an embodiment of the present invention.

### DETAILED DESCRIPTION OF THE EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Throughout the specification, like reference numerals in the drawings denote like elements.

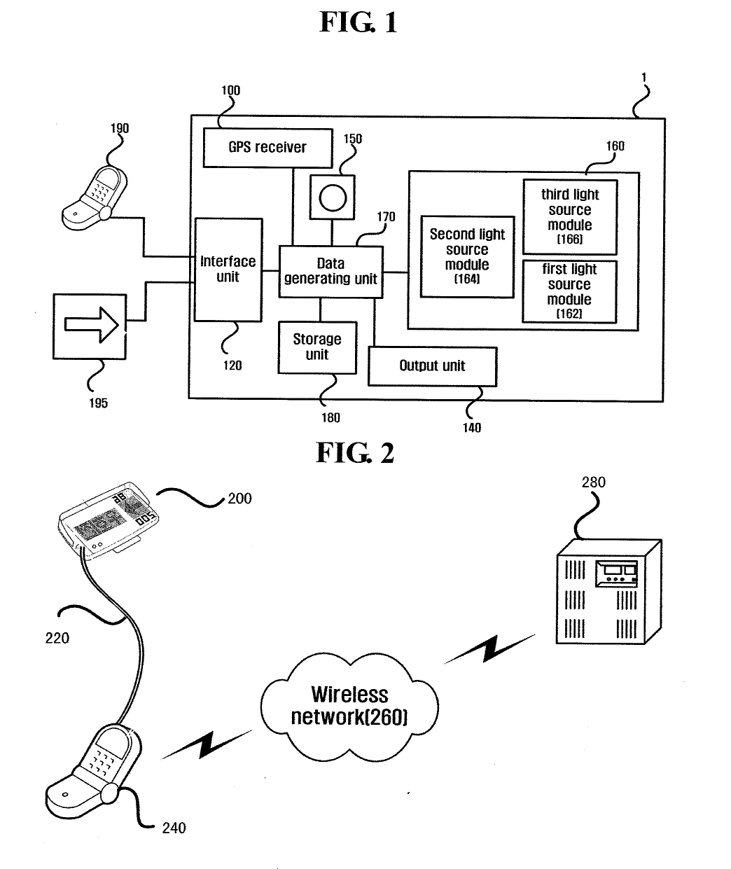

Configuration and operation of a head-up display navigation device according to an embodiment of the present invention will now be described with reference to FIG. 1. FIG. 1 is a block diagram of the head-up display navigation device according to the embodiment of the present invention. As shown in FIG. 1, the head-up display navigation device 1 according to this embodiment may include a GPS receiver 100, an interface unit 120, an output unit 140, a light source unit 160, a data generating unit 170, and a storage unit 180. The GPS receiver 100 receives GPS data from GPS satellites and provides GPS data indicating the current position (hereinafter referred to as “current GPS position data”) to the data generating unit 170. The GPS receiver 100 may provide the current GPS position data to the data generating unit 170 at regular time intervals. The head-up display navigation device 1 according to this embodiment need not include the GPS receiver 100. When the head-up display navigation device 1 does not include the GPS receiver 100, the current GPS position data is generated using data provided from an external GPS unit to which the head-up display navigation device 1 is connected through the interface unit 120. Here, the external GPS unit may be a device for receiving GPS data from GPS satellites. For example, the external GPS unit may be an external GPS receiver or a mobile terminal having a GPS reception function. The mobile terminal may be, but is not limited to, a mobile phone.

The head-up display navigation device 1 according to this embodiment may obtain the current GPS position data by estimating the current position of the mobile terminal through a Location-Based Service (LBS) using distances between the mobile terminal and adjacent mobile communication base stations, radio states, and the like.

The interface unit 120 is connected to the external device 190, and receives GPS route data provided by the external device 190 and provides the received GPS data to the data generating unit 170. The external device 190 may be connected to the interface unit 120 using a wired communication scheme. The wired communication scheme may be, for example, Universal Serial Bus (USB) or RS-232. The output unit 140 receives sound data corresponding to at least part of navigation data from the data generating unit 170 and reproduces a corresponding sound. The sound data may be, for example, voice data or sound effect data.

The data generating unit 170 compares the current GPS position data with the GPS route data received from the external device 190 through the interface unit 120 and generates navigation data. The navigation data may include travel signal data. The travel signal data may include, for example, predefined codes indicating left-turn, right-turn, U-turn, straight, overpass entry, or tunnel entry. The navigation data may further include current speed data that the data generating unit 170 calculates by updating the current GPS position data at specific time intervals.

The light source unit 160 projects a horizontally mirrored image, a horizontally mirrored character(s), and a horizontally mirrored numeric value, which correspond to at least part of the navigation data provided from the data generating unit 170, onto a windshield. The light source unit 160 may comprise a first light source module 162 which is of dot-matrix type and projects the horizontally mirrored image, a second light source module 164 which is of dot-matrix type and projects the horizontally mirrored character, or a third light source module 166 which is of 7-segment type and projects the horizontally mirrored numeric value. The first light source module 162, the second light source module 164, and the third light source module 166 may be of any type, provided that they are self-emission light sources. For example, each of the first to third light source modules may be constructed using a Light Emitting Diode (LED) or an Organic Light Emitting Diode (OLED).

The head-up display navigation device 1 according to this embodiment may further include a light source sensor 150. The light source sensor 150 includes one or more light source sensor modules and measures the intensity of incident light and provides the light intensity measurement data to the data generating unit 170. The data generating unit 170 may receive the light intensity measurement data and control the light source unit 160 to increase the intensity of emitted light of the light source unit 160 as the measured light intensity increases.

The head-up display navigation device 1 according to this embodiment may further include an external display device 195 that displays at least one of an image, a character, or a numeric value corresponding to at least part of the navigation data generated by the data generating unit 170. The external display device 195 may be, for example, an LED display, or an OLED display. Here, it should be noted that the image, the character, and the numeric value displayed on the external display device 195 are not horizontally mirrored since they are displayed outside of the vehicle, for example, displayed to a driver of another vehicle at the rear side.

The operation of the head-up display navigation device 1 according to this embodiment will now be described.

The data generating unit 170 receives GPS route data from the external device 190 through the interface unit 120. The GPS receiver 100 provides current GPS position data to the data generating unit 170 at regular time intervals. The GPS route data includes data regarding a route from a departure point to destination, which is recorded based on GPS data. The GPS route data includes travel signal data on the route. For example, this GPS data may include data, analysis of which indicates that a right-turn signal is generated at a first point represented by GPS data and a left-turn signal is generated at a second point represented by GPS data. That is, the GPS route data may be a data structure including basic units, each including an ordered pair of GPS data and travel signal data at a specific position. The data structure may be, for example, a data structure including arrays or linked lists. The travel signal data may be one-to-one mapped travel signal code data. For example, the travel signal data may be allocated a predetermined code of “0” for straight, “1” for right-turn, “2” for left-turn, and “3” for U-turn. The data generating unit 170 compares the GPS route data with the current GPS position data and generates navigation data. The navigation data may be generated through a first step of determining current travel direction, a second step of searching for travel signal data in the GPS route data within a reference distance from the current position, assuming that the vehicle will travel in the same direction as the current travel direction, and a third step of generating, when travel signal data is found in the GPS route data within the reference distance, data including the travel signal data and a distance from the current position to a reference point corresponding to the travel signal. The navigation data may further include current speed data that the data generating unit 170 calculates by updating the current GPS position data at specific time intervals.

The data generating unit 170 may generate numeric value data including a distance to the reference point and a current speed and control the third light source module 166 to project a horizontally mirrored image of the numeric value. For example, the third light source module 166 may project horizontally mirrored images of “200” and “40” when the current speed is 40 km/h and the distance to the reference point is 200 m.

The data generating unit 170 may generate image data corresponding to the travel signal and control the first light source module 162 to project a horizontally mirrored image of the image. The image data may be an icon corresponding to at least part of the navigation data. Specifically, the image data may be an icon that is mapped one to one to each travel signal in the navigation data. For example, when the travel signal code data is “1”, the first light source module 162 projects a “left arrow” image which is a horizontally mirrored image of a “right arrow” image that is mapped to “right-turn”.

The data generating unit 170 may generate character data corresponding to the travel signal and control the second light source module 164 to project a horizontally mirrored image of the character. The character data may be a character corresponding to at least part of the navigation data. Specifically, the character data may be a character that is mapped one to one to each travel signal in the navigation data. For example, when the travel signal code data is “1”, the second light source module 164 projects a horizontally mirrored image of the word “right-turn” that is mapped to “right-turn”.

The data generating unit 170 may generate sound data corresponding to the travel signal and provide the sound data to the output unit 140 to allow the output unit 140 to reproduce a corresponding sound. The sound data may be a sound corresponding to at least part of the navigation data. Specifically, the sound data may be a sound that is mapped one to one to each travel signal in the navigation data. For example, when the travel signal code data is “1” and the distance to the reference point is 200 m, the output unit 140 reproduces a sound message of “Turn right 200 meters ahead”.

The storage unit 180 stores current GPS position data, GPS route data received from the external device 190, and sound data, navigation data, image data, character data, and numeric value data generated by the data generating unit 170.

The head-up display navigation device according to the present invention described above has an advantage in that it is possible to provide a head-up display navigation service based on up-to-date map data stored in the server using an external device having no GPS receiver. Thus, it is possible to reduce costs required to store map data in a user device and it is also possible to always provide a head-up display navigation service through up-to-date navigation data since the navigation data is generated by receiving, in real time, route data generated using up-to-date map data in the server.

The head-up display navigation device according to this embodiment also has an advantage in that it is possible to display a numeric value, an image, and a character separately in space and the light source module used to project a numeric value is of a 7-segment type most suitable for numeric value projection, thereby increasing visibility of a head-up display image to the driver.

In addition, the head-up display navigation device according to this embodiment has an advantage in that it is possible to maintain visibility of a head-up display image to the driver even when the intensity of external light is high since the intensity of emitted light of the light source unit increases as the intensity of external light increases.

Further, the head-up display navigation device according to this embodiment has an advantage in that it is possible to notify another vehicle's driver of travel information of the vehicle, in which the head-up display navigation device according to this embodiment is installed, through the external display device, thereby preventing accidents.

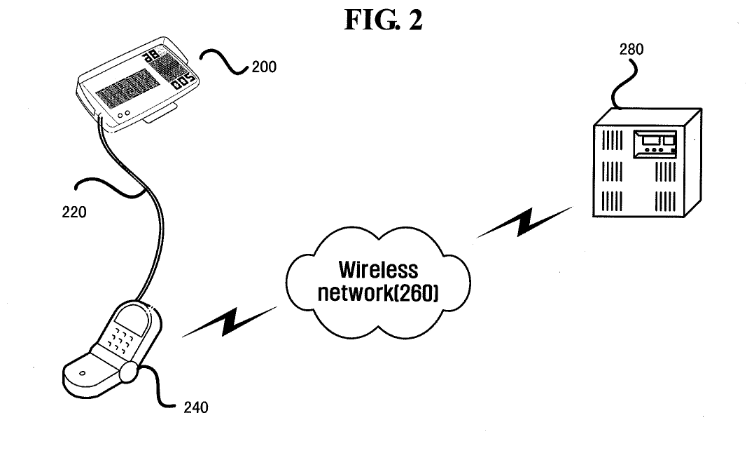

Configuration and operation of a head-up display navigation system according to another embodiment of the present invention is described below with reference to FIG. 2. FIG. 2 is a block diagram of the head-up display navigation system according to the embodiment of the present invention. As shown in FIG. 2, the head-up display navigation system of this embodiment includes a head-up display navigation device 200, a mobile terminal 240, and a server 280. The mobile terminal 240 receives departure point data and destination data from a user and transmits a route request message including the departure point data or the destination data to the server 280 through a wireless network 260. When the mobile terminal 240 receives GPS route data from the server 280 in response to the route request message through the wireless network 260, the mobile terminal 240 provides the received GPS route data to the head-up display navigation device 200 that is connected to the mobile terminal 240 through a data cable 220.

The data cable 220 connects the head-up display navigation device 200 and the mobile terminal 240 and may employ, for example, a USB or RS-232 scheme.

The head-up display navigation device 200 compares the GPS route data provided from the mobile terminal 240 with current GPS position data provided through the GPS receiver or interface unit and generates navigation data. The head-up display navigation device 200 then projects at least one of a horizontally mirrored image, a horizontally mirrored character, or a horizontally mirrored numeric value corresponding to at least part of the navigation data.

Navigation data images that it is difficult for the head-up display navigation device 200 to generate may be replaced with sample images provided by the mobile terminal 240.

The server 280 generates GPS route data from departure point data and destination data, which are received from the mobile terminal 240 through the wireless network 260, and road information data, which is previously stored in the server 280, and transmits the generated GPS route data to the mobile terminal 240 through the wireless network 260. Here, the server 280 may generate and provide a single GPS route data item and one or more GPS route data items based on received departure point data and destination data.

In addition, the server 280 transmits not only the navigation data but also preset information data (for example, content data of a category subscribed to by the user) and additional data (for example, weather and breaking news) to the mobile terminal 240.

The wireless network 260 may employ, but is not limited to, a Code Division Multiple Access (CDMA) scheme or a Global System for Mobile communications (GSM) scheme.

An operation of the head-up display navigation system according to this embodiment is described below.

The mobile terminal (or mobile terminal) 240 receives departure point data and destination data from the user and transmits the received data to the server 280 through the wireless network 260. The server 280 generates GPS route data from the departure point data, the destination data, and the stored road information data and then transmits the GPS route data to the mobile terminal 240 through the wireless network 260.

The mobile terminal 240 may additionally receive stopover data from the user and transmit the stopover data to the server 280 and the server 280 may then generate the GPS route data with reference to the stopover data.

The server 280 may generate the GPS route data with reference to Congestion and Travel Time information (CTT). The server 280 may also generate the GPS route data with reference to Safe Driving Information (SDI). The server 280 may generate the GPS route data with reference to a Road Traffic Message (RTM).

The mobile terminal 240 receives the GPS route data from the server 280 through the wireless network 260 and provides the received GPS route data to the head-up display navigation device 200 through the data cable 220.

The head-up display navigation device 200 receives current GPS position data through the GPS receiver or the interface unit and compares the current GPS position data with the GPS route data to generate navigation data. The current GPS position data may be generated through a GPS receiver provided in the head-up display navigation device 200.

The head-up display navigation device 200 projects a horizontally mirrored image, a horizontally mirrored character, or a horizontally mirrored numeric value corresponding to at least part of the navigation data onto the windshield.

When the head-up display navigation device 200 has determined that the vehicle has left the route by comparing the current GPS position data with the GPS route data, the head-up display navigation device 200 provides a route re-search message including the current GPS position data to the mobile terminal 240.

The mobile terminal 240 transmits the current GPS position data included in the re-search message as new departure point data, together with the destination data, to the server 280. The server 280 generates new GPS route data using the departure point data and the destination data and transmits the new GPS route data to the mobile terminal 240 and the mobile terminal 240 then provides the new GPS route data to the head-up display navigation device 200. The head-up display navigation device 200 regenerates navigation data using the new GPS route data and the current GPS data.

The head-up display navigation system according to this embodiment can project content of a category subscribed to by the user through the head-up display navigation device. Details of this operation are described as follows.

When stored content data has been updated, the server 280 transmits the updated content data to the mobile terminal 240 through the wireless network 260. The mobile terminal 240 provides the content data to the head-up display navigation device 200 through the data cable 220. The head-up display navigation device 200 projects an image, a numeric value, or a character corresponding to at least part of the content data. The content data may be content data of a category subscribed to by the user. The user may select the category through the mobile terminal 240. The head-up display navigation system according to the present invention has an advantage in that it is possible to provide a head-up display navigation service based on up-to-date map data stored in the server using a mobile terminal having no GPS receiver. Thus, it is possible to reduce costs required to store map data in a user device and it is also possible to always provide a head-up display navigation service through up-to-date navigation data since the navigation data is generated by receiving, in real time, route data generated using up-to-date map data in the server.

The head-up display navigation system according to the present invention also has an advantage in that it is possible to receive and present not only navigation data but also preset information data in real time from the server.

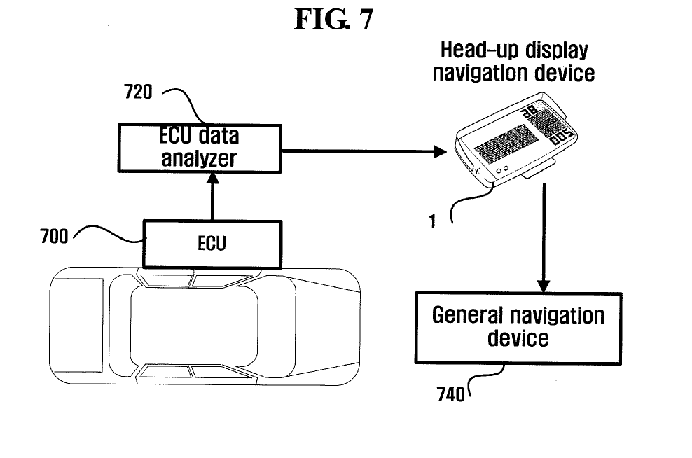

In an exemplary application of this embodiment, as shown in FIG. 7, the head-up display navigation device 1 may process at least part of data generated by an Electronic Control Unit (ECU) 700 provided in a vehicle and project at least one of a horizontally mirrored image, a horizontally mirrored character, or a horizontally mirrored numeric value onto a windshield. Although the head-up display navigation device 1 may be directly connected to the ECU 700 to read data generated by the ECU 700, the head-up display navigation device 1 may also receive data generated by the ECU 700 via an ECU data analyzer 720 which analyzes the data as shown in FIG. 7. In this case, the head-up display navigation device 1 converts the data analyzed by the ECU data analyzer 720 into at least one of a horizontally mirrored image, a horizontally mirrored character, or a horizontally mirrored numeric value and projects the converted data onto the windshield without performing an operation for analyzing the data.

When the head-up display navigation device 1 receives data via the ECU data analyzer 720, there is an advantage in that it is possible to minimize the risk that the head-up display navigation device 1 damages ECU circuitry or the like.

Examples of data that may be projected onto the windshield through the head-up display navigation device 1 include data as to whether or not the engine has initialized normally, data regarding current RPM, and data regarding the amount of injected fuel (or gas).

In addition, as shown in FIG. 7, the head-up display navigation device 1 may also transfer received ECU data to a general navigation device 740. In this case, it is preferable that the head-up display navigation device 1 transfer received ECU data to the general navigation device 740 without processing the ECU data. However, data packing may be performed on the ECU data to allow the ECU data to pass through a connection means between the head-up display navigation device 1 and the general navigation device 740.

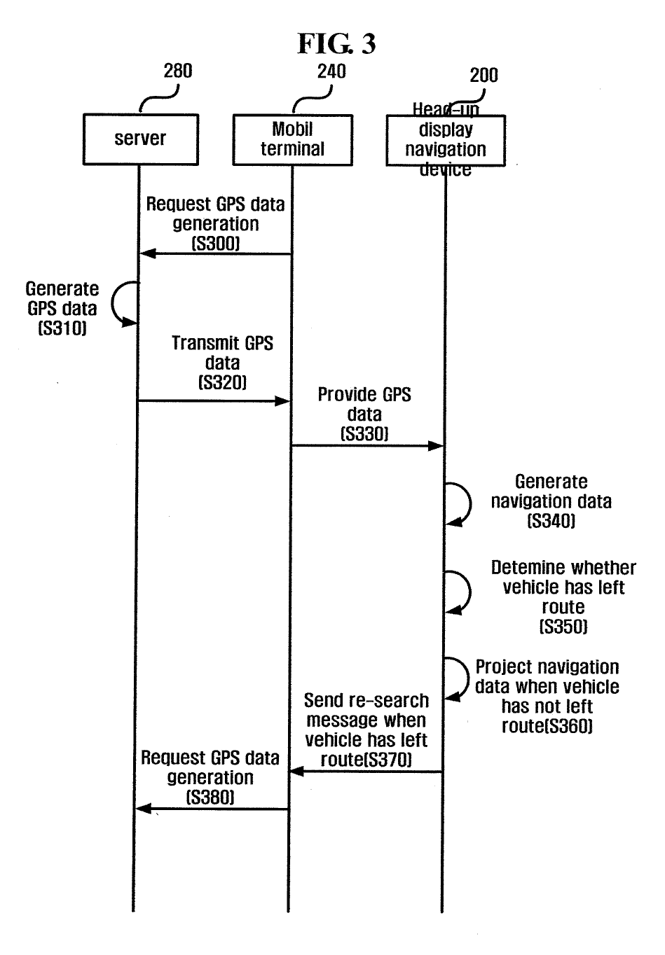

A method for implementing a head-up display navigation service according to another embodiment of the present invention is described below with reference to FIG. 3. FIG. 3 is a flow chart of the method for implementing a head-up display navigation service according to the embodiment of the present invention.

The mobile terminal (or mobile terminal) 240 wirelessly transmits departure point data and destination data input by the user to the server 280 to request GPS route data (S300).

The server 280 generates GPS route data from the departure point data, the destination data, and previously stored road information data (S310) and transmits the GPS route data to the mobile terminal 240 (S320).

The mobile terminal 240 receives and provides the GPS route data to the head-up display navigation device 200 (S330).

The head-up display navigation device 200 receives current GPS position data from the GPS receiver or the interface unit and compares the current GPS position data with the GPS route data to generate navigation data (S340).

The head-up display navigation device 200 determines whether or not the vehicle has left the route by comparing the current GPS position data with the GPS route data (S350).

Upon determining that the vehicle has not left the route, the head-up display navigation device 200 projects at least one of a horizontally mirrored image, a horizontally mirrored character, or a horizontally mirrored numeric value corresponding to at least part of the navigation data onto the windshield (S360).

Upon determining that the vehicle has left the route, the head-up display navigation device 200 provides a route re-search message, in which the current GPS position data is included as new departure point data, to the mobile terminal 240 (S370). Upon receiving the route re-search message, the mobile terminal 240 transmits the new departure point data and the destination data to the server 280 (S380). That is, the mobile terminal 240 transmits the current GPS position data included in the route re-search message as new departure point data, together with the destination data, to the server 280. The procedure of steps S300 to S350 is repeated when the process of step S380 has been performed. Upon determining that the vehicle has not left the route, the head-up display navigation device 200 projects a horizontally mirrored image, a horizontally mirrored character, or a horizontally mirrored numeric value corresponding to at least part of the navigation data onto the windshield (S380).

The method for implementing a head-up display navigation service according to the present invention has an advantage in that it is possible to provide a head-up display navigation service based on up-to-date map data stored in the server using a mobile terminal having no GPS receiver. Thus, it is possible to reduce costs required to store map data in a user device and it is also possible to always provide a head-up display navigation service through up-to-date navigation data since the navigation data is generated by receiving, in real time, route data generated using up-to-date map data in the server.

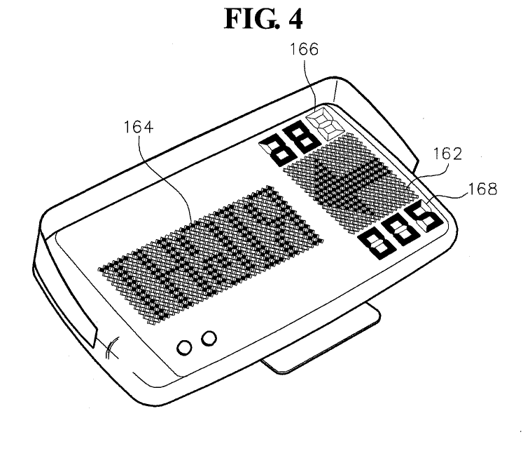

A configuration and operation of a head-up display navigation device according to another embodiment is described below with reference to FIG. 4. FIG. 4 illustrates the front side of the head-up display navigation device according to this embodiment.

The head-up display navigation device according to this embodiment includes a light source unit 160 including a fourth light source module 168 in addition to the first light source module 162, the second light source module 164, and the third light source module 166. The fourth light source module 168 may be a 7-segment-type light source. The data generating unit 170 may control not only the first to three light source modules 162, 164, and 166 but also the fourth light source module 168. The light source sensor 150 of the head-up display navigation device according to this embodiment includes one or more light source sensor modules for measuring the intensity of light and provides light intensity measurement data to the data generating unit 170.

For example, when current speed is 86 km/h, a distance to the destination is 200 km, and a current travel signal is “right-turn”, the navigation data may include data such as “86|200|right-turn code”.

Thus, the data generating unit 170 generates a first control signal allowing the first light source module 162 to project light of a horizontally mirrored image (i.e., a left arrow image) of the travel signal image and a second control signal allowing the second light source module 164 to project light of a horizontally mirrored image of the travel signal text (i.e., turn right).

In addition, the data generating unit 170 generates a third control signal allowing the third light source module 166 to project light of a horizontally mirrored numeric value image of the current speed “86” and a fourth control signal allowing the fourth light source module 168 to project light of a horizontally mirrored numeric value image of the remaining distance data “200”.

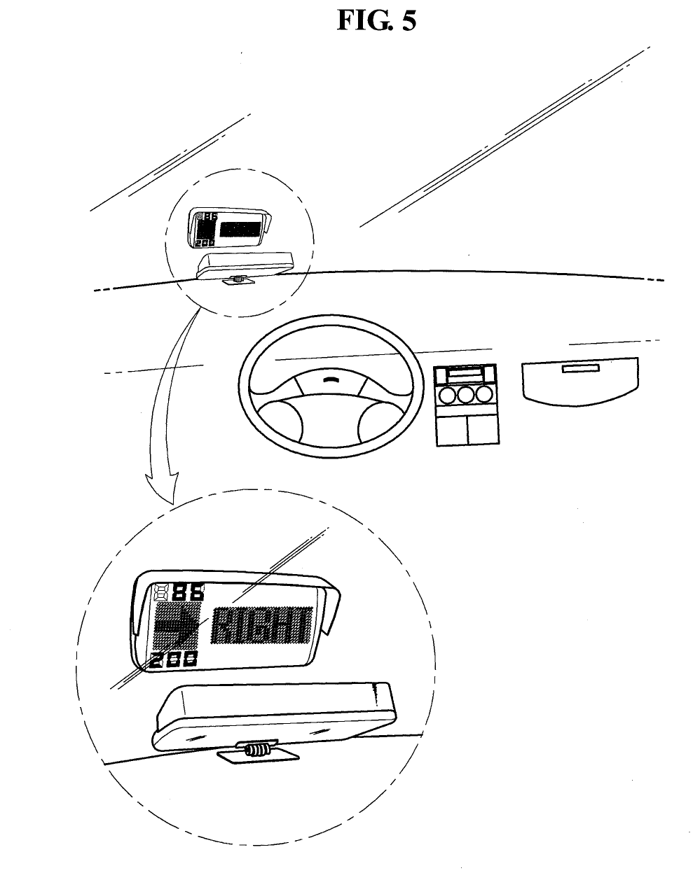

FIG. 5 illustrates a head-up display screen according to this embodiment. The first to fourth control signals generated by the data generating unit 170 allow the light source unit 160 to project light of a horizontally mirrored screen image as shown in FIG. 4 so that the user can view a correctly-oriented head-up display screen inside the vehicle as shown in FIG. 5.

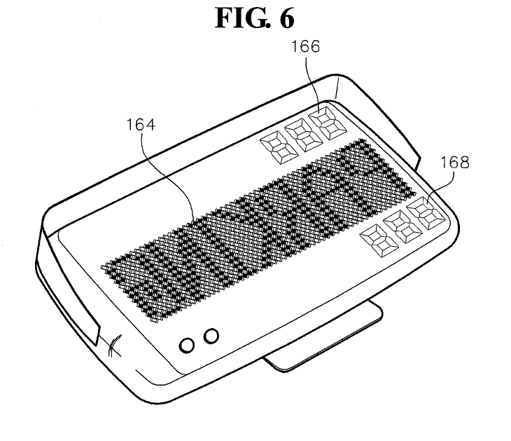

FIG. 6 illustrates an example in which additional information is provided to a head-up display navigation device according to an embodiment of the present invention.

As shown in FIG. 6, additional information (for example, a contact number and a message of the user) is provided to the second light source module 164 of the head-up display navigation device. Here, the data generating unit in the head-up display navigation device generates a signal allowing additional information stored in the storage unit to be provided to the second light source module 164. The data generating unit also allows an internal battery of the head-up display navigation device to apply power to the second light source module 164 to display the additional information. Although the additional information is provided to the second light source module 164 in this example, the present invention is not limited to this example and additional information may be provided to one or more of the first to fourth light source modules 162 to 168. The additional information may also include one or more information items.

For example, when the engine of a vehicle in which the head-up display navigation device is installed is turned off, information of a message “short stay” is provided to the second light source module 164 of the head-up display navigation device.

According to the present invention, even when a head-up display navigation device is not installed in a conventional vehicle, it is possible to easily implement a head-up display navigation system by projecting a horizontally mirrored image of navigation data onto a windshield using a detachable head-up display navigation device. Here, since route data is provided from an external device, the head-up display navigation device does not need to manage map data or the like so that it is possible to reduce costs and also to use map data stored in a general navigation device.

What is claimed is:

1. A head-up display navigation device comprising:
a data generating unit that generates navigation data by comparing current GPS position data with GPS route data provided from an external device; and
a light source unit that projects at least one of a horizontally mirrored image, a horizontally mirrored character, or a horizontally mirrored numeric value corresponding to at least part of the navigation data onto a windshield.

2. The head-up display navigation device according to claim 1, further comprising an output unit that reproduces a sound corresponding to at least part of the navigation data.

3. The head-up display navigation device according to claim 1, wherein the current GPS position data is provided from an external device.

4. The head-up display navigation device according to claim 1, further comprising a GPS receiver that receives the current GPS position data.

5. The head-up display navigation device according to claim 1, wherein the data generating unit compares the GPS route data with the current GPS position data to determine whether or not route deviation has occurred and generates a route re-search message including the current GPS position data upon determining that route deviation has occurred.

6. The head-up display navigation device according to claim 1, wherein the light source unit comprising:
a first light source module that is a dot-matrix type and projects the horizontally mirrored image;
a second light source module that is of a dot-matrix type and projects the horizontally mirrored character; and
a third light source module that is of a 7-segment type and projects the horizontally mirrored numeric value.

7. The head-up display navigation device according to claim 1, further comprising an external display unit that displays at least one of an image, a character, and a numeric value corresponding to at least part of the navigation data.

8. A head-up display navigation system comprising:
a server that generates GPS route data using departure point data, destination data, and previously stored road information data;
a mobile terminal that requests the server to generate the GPS route data and provides the GPS route data transmitted from the server to a head-up display navigation device; and
the head-up display navigation device that compares the GPS route data provided from the mobile terminal with current GPS position data to generate navigation data and projects at least one of a horizontally mirrored image, a horizontally mirrored character, or a horizontally mirrored numeric value corresponding to at least part of the navigation data onto a windshield.

9. The head-up display navigation system according to claim 8, wherein the head-up display navigation device compares the current GPS position data with the GPS route data to determine whether or not route deviation has occurred and provides a route re-search message including the current GPS position data to the mobile terminal upon determining that route deviation has occurred, and
the mobile terminal transmits the current GPS position data included in the re-search message as new departure point data to the server.

10. The head-up display navigation system according to claim 8, wherein the mobile terminal wirelessly receives updated content data from the server, and
the head-up display navigation device projects an image, a numeric value, or text corresponding to at least part of the content data provided from the mobile terminal.

11. The head-up display navigation system according to claim 8, wherein the head-up display navigation device processes at least part of data generated by an Electronic Control Unit (ECU) provided in a vehicle and additionally projects at least one of a horizontally mirrored image, a horizontally mirrored character, or a horizontally mirrored numeric value onto a windshield.

12. The head-up display navigation system according to claim 11, wherein the head-up display navigation device receives ECU data analyzed by an ECU data analyzer and converts the received data into at least one of a horizontally mirrored image, a horizontally mirrored character, or a horizontally mirrored numeric value and projects the converted data onto the windshield.

13. A method for implementing a head-up display navigation service, the method comprising:
comparing current GPS position data with GPS route data provided from an external device to generate navigation data; and
projecting at least one of a horizontally mirrored image, a horizontally mirrored character, or a horizontally mirrored numeric value corresponding to at least part of the navigation data onto a windshield.

14. The head-up display navigation system according to claim 13, further comprising:
comparing the GPS route data with the current GPS position data to determine whether or not route deviation has occurred and providing a route re-search message including the current GPS position data to the external device upon determining that route deviation has occurred.
